(19) United States
(12) Patent Application Publication
(10) Pub. No.: US 2025/0243954 A1
(43) Pub. Date: Jul. 31, 2025

(54) CONNECTING ELEMENT FOR HOSES, PIPES OR OTHER FLUID TRANSPORT DEVICES

(71) Applicant: Andreas Gitterle, Gallspach (AT)

(72) Inventor: Andreas Gitterle, Gallspach (AT)

(21) Appl. No.: 19/040,260

(22) Filed: Jan. 29, 2025

(30) Foreign Application Priority Data
Jan. 30, 2024 (AT) A 50073/2024

(51) Int. Cl. F16L 15/00

(52) U.S. Cl. CPC F16L 15/008; F16L 2201/60

(57) ABSTRACT

The invention relates to a connecting element for hoses, pipes or other fluid transportation devices, having at least two connecting parts, wherein the connecting parts can be screwed together about screw axes of the connecting parts, wherein at least one connecting part has at least one receptacle for a seal for sealing the connection between at least two of the connecting parts, wherein a first connecting part has at least one first scale with a plurality of measurement markings and a second connecting part has at least one second scale with at least two reference markings, and wherein the first scale and the second scale are opposite one another in the screwed state and can be rotated relative to one another by turning the screw connection.

The invention relates to a connecting element for hoses, pipes or other fluid transport devices, having at least two connecting parts, wherein the connecting parts can be screwed together about screw axes of the connecting parts, wherein at least one connecting part has at least one receptacle for a seal for sealing the connection between at least two of the connecting parts.

It also relates to a method for connecting hoses, pipes or other fluid transport devices by means of a connecting element comprising at least two connecting parts, wherein the connecting parts are each flow-connected to at least one hose, pipe or other fluid transport device, wherein at least one seal is arranged in or on at least one receptacle of at least one connecting part and the connecting parts are screwed into one another.

It also concerns a marking kit.

Connecting elements as described above are used in various areas, in particular for transporting fluids such as liquids or gases, for example fuel, solvents or other chemicals. It is essential that the connection is tight, which is why a seal is inserted into the connecting element.

The connecting element is used to create a fluid connection. The two fluid-carrying components connected in this way can be the same or different. As a rule, these are pipes or hoses. However, they may also be fluid tanks, for example.

Sufficient sealing of the connection is important for the function of the connecting element. A seal provided for this purpose is subjected to a contact pressure or pressed together by at least two screwed connecting parts. The contact pressure must be sufficiently high to ensure adequate tightness. At the same time, the contact pressure must not be too high, as this could otherwise have a negative effect on the components, in particular on the seal, such as breakage, deformation or accelerated ageing. During manual or mechanical screwing, the contact pressure is usually difficult to adjust.

In EP 1 382 793 A1, it is proposed that two connecting parts each have a marking which must be brought into alignment by screwing in order to guarantee sufficient tightness. However, this solution does not have a receptacle for a seal, which limits its tightness.

In EP 0 139 565 A1, a seal is provided, which increases the tightness. A single marking is arranged on a connecting part, which is brought into alignment with a recess, indicating that the sufficient degree of twisting has been achieved.

However, this does not allow fine adjustment of the contact pressure. In addition, incomplete or excessive twisting and a resulting incorrect contact pressure can occur if the installed seal has even small manufacturing tolerances or a seal of a different material or shape, such as thickness, is used. This leads to a contact pressure that cannot be set precisely, which reduces the tightness and entails the risk of damage to the seal.

It is therefore the object of the invention to provide a connecting element and a method as described above, which enables improved tightness and the longest possible tightness of the connection.

This object is solved in accordance with the invention in that a first connecting part has at least one first scale with a plurality of measurement markings and a second connecting part has at least one second scale with at least two reference markings, and in that the first scale and the second scale are opposite one another in the screwed state and can be rotated relative to one another by turning the screw connection.

It is also solved in that the method comprises the following further steps:
a. at least one first connecting part and at least one second connecting part are screwed into one another into a first screw position until at least one connecting part rests against a seal of at least one other connecting part, in that;
b. the position of at least a first reference marking of at least a second scale, which is arranged on a second connecting part, is recognized in relation to a plurality of measurement markings of at least a first scale, which is arranged on a first connecting part, in the first screwing position, and;
c. the connecting parts are then further screwed together until at least one other reference marking on the second scale assumes at least essentially the same position in relation to the first scale as the first reference marking during the first screw position.

It is also solved by a marking kit having the features of the corresponding independent claim.

The arrangement of the first and second scales allows the contact pressure of the seal to be set individually. Because the first scale has a plurality, i.e. at least three, preferably at least five, particularly preferably at least ten and very particularly preferably at least 30 measurement markings, the position of a first reference marking, for example a start reference marking, can be determined relative to the position of the measurement markings, preferably at least one closest measurement marking, when the connecting parts are screwed into one another in a first screw position and both connecting parts are in contact with the seal, but are not yet pressing against it or are pressing against it only insignificantly. A defined contact pressure is ensured by further screwing until a second reference marking, for example an end reference marking, is in essentially the same position opposite the first scale in which the first reference marking was in the first screw position.

One advantage of the invention can be seen in particular in the fact that manufacturing tolerances of a seal no longer have any influence on the contact pressure. For example, if the thickness of the seal is slightly greater or smaller, the first screw position is reached sooner or later without the degree of screwing, which determines the contact pressure, being changed.

A further advantage of the invention can be seen in particular in the fact that the ageing of the seal or another change in the seal or its properties, for example due to a change in external conditions such as a change in temperature, can also be monitored and reacted to. By recording the first screw position, it is possible to subsequently check whether the seal has been compressed when it is loosened and screwed together again until it comes into contact with the seal.

In this sense, it is also possible to react to corresponding ageing by screwing the seal back together again until it is in contact with the first scale and a second reference marking-the same or a different second reference marking in relation to the first screwing-is in the same position in relation to the first scale. An aged seal, which has a reduced tightness due to its change in shape, can thus be brought into a position in which it seals sufficiently again and can continue to be used. This increases the service life of the seal, during which it can seal tightly.

If at least one connecting part is in contact with a seal of at least one other connecting part, the seal can exert a counterforce against the further rotation or brake the further rotation. This counterforce or braking is easily noticeable by the user during screwing together, who recognizes that the first screwing position has been reached.

The expression “facing each other” means that the relative position of the first and second scales to each other can be determined, preferably easily determined. In other words, they are close to each other so that their rotation relative to each other can be determined when the first connecting part and the second connecting part are screwed together.

The first scale is arranged on the first connecting part and the second scale is arranged on the second connecting part.

It may be provided that the first scale is connected to the first connecting part via a materially bonded connection and/or the second scale is connected to the second connecting part via a materially bonded connection. Such a materially bonded connection may, for example, comprise bonding, welding, soldering or vulcanization. In this sense, the first scale and/or the second scale may comprise an adhesive strip or sticker.

It may be provided that the first scale is connected to the first connecting part via a force-fitting and/or form-fitting connection and/or the second scale is connected to the second connecting part via a force-fitting and/or form-fitting connection. Such a force-fitting connection can, for example, involve pressing or crimping the scale onto the connecting part. A form-fitting connection can, for example, comprise corresponding engaging elements such as plug-in connections.

It may also be provided that the first scale will be or is applied additively to the first connecting part and/or that the second scale will be or is applied additively to the second connecting part. The expression additively applied means that at least part of the respective scale is applied by adding material to the respective connecting part. For example, a scale can be printed, laser-marked or painted on.

It may also be provided that the first scale is or is applied subtractively to the first connecting part and/or that the second scale is or is applied subtractively to the second connecting part. The expression subtractively applied means that at least part of the respective scale is applied to the respective connecting part by material consumption. For example, a scale can be milled, engraved, laser-engraved or scribed.

In the context of the invention, a seal is understood to be a sealing element which, when installed in the connecting element and screwed to the connecting parts as intended, seals the connection of the connecting parts so that the fluid to be transported does not escape or only escapes in insignificant quantities. Preferably, the seal comprises at least one element that has greater elasticity than at least one of the connecting parts. Preferably, the seal comprises at least one sealing ring, such as an O-ring, a molded seal and/or a flat seal.

The sequence of the method steps does not necessarily have to be carried out in the order listed in the claims; it is possible that the method steps are carried out in a different sequence, that additional method steps are carried out in between and/or that at least two method steps are carried out simultaneously. For example, the flow connection of the connecting parts with at least one hose, pipe or other fluid transport device can be carried out at the end of the method or at another point during the method.

Preferably, the connecting parts or at least one connecting part have at least one thread. This makes it possible to screw them together. The thread of at least one connecting part preferably comprises at least one surface that is inclined in relation to the circumference of the connecting part. This makes it possible to change the distance along the screw axes between the connecting parts when they are rotated relative to each other.

It may be provided that the first connecting part and/or the second connecting part has an insert part and a screw part that can be rotated relative to the insert part, wherein the screw part has at least one thread for screwing to the other connecting part. If the first connecting part has a screw part, the other connecting part for this screw part is the second connecting part. If the second connecting part has a screw part, the other connecting part for this screw part is the first connecting part. The insert part and/or the screw part can be parts of the main body.

The insert part is usually inserted into the screw part, for example inserted, plugged in or screwed in. It is also possible for the insert part to be connected to the screw part in another way.

The first scale and/or second scale can be arranged on the screw part of the respective connecting part. A connecting region for coupling with the fluid transport device of the respective connecting part can preferably be arranged on the insert part of this connecting part.

Such a screw part makes it easier to screw together without having to turn the insert part.

It is preferably provided that the relative, axial movement of the screw part in relation to the insert part is positively limited, at least in the direction of the screw connection. This can be achieved, for example, by a shoulder that limits the movement.

In the direction of the screw connection means in the direction of the other connecting part.

It is preferably provided that the relative, axial movement of the screw part with respect to the insert part is limited at least against the direction of the screw connection, preferably with a positive fit. This can be achieved, for example, by a shoulder that limits the movement. A shoulder as described in the last paragraphs can, for example, be provided by at least one insert in the insert part and/or in the screw part, for example an insert ring, preferably made of plastic or rubber.

It is preferably provided that a relative, axial movement of the screw part with respect to the insert part against the direction of the screw connection is limited up to a first end position, and that the screw part projects beyond the insert part in the axial direction and on the side of the screw connection in the first end position. This ensures that the insert part always starts behind the screw part on the side of the screw connection, whereby it is protected by the screw part.

It is preferably provided that a relative, axial movement of the screw part with respect to the insert part against the direction of the screw connection is limited up to a first end position, that the screw part in the end position projects in the axial direction and on the side of the screw connection beyond a contact surface of the insert part for contacting the seal. The contact surface can comprise a pressing wall or contact wall and/or can be part of a groove. This ensures that the contact surface is protected from damage by the screw part.

It is preferably provided that the screw part is guided in an axial direction along the insert part via a form-fitting guide. This can be achieved, for example, by corresponding diameters of concentrically arranged connecting walls of the screw part and the insert part.

It is preferably provided that a threaded section of the connecting part, which has an internal thread, is spaced apart from the other connecting part in the axial direction in the screwed state. This prevents the screw connection from being limited by the threaded part protruding. The threaded section is the part or section of the connecting part on which the thread is arranged directly. For example, the threaded section can be a threaded socket.

It is preferably provided that the connecting parts are each set up for flow connection with at least one hose, pipe or other fluid transport device or are flow-connected to them.

The expression “set up for flow connection with at least one hose, pipe or other fluid transport device” means that the connecting parts can either be connected to a hose, pipe or other fluid transport device or are already connected to them, for example separably, inseparably, in one piece and/or in several pieces. Preferably, at least one connection part has at least one connecting region for connection to at least one hose, pipe or other fluid transport device.

It may be provided that at least one connecting part has at least one connecting region which is set up for flow connection with at least one hose, pipe or other fluid transport device. It may be provided that this connecting part can be rotated or pivoted relative to at least one other part of the connecting part, preferably at least relative to a main body of the connecting part.

It may be provided that at least one connecting part has at least one gripping section. This gripping section can be set up for connection with a tool or for manual operation. This can make screwing easier. At least one gripping section may have at least one contoured or structured surface and/or at least one hexagonal shape.

The receptacle for the seal preferably has at least one contact surface on which the seal rests in the screwed state and is preferably pressed on by at least one other connecting part. The receptacle can also include a notch or recess in which the seal can be inserted. It is also possible for the seal to be pushed onto, inserted into or applied to the receptacle.

A reference marking and/or measurement marking can be designed in different ways. In a simple case, it can comprise or be lines. They can also be indentations, elevations, color markings or other-preferably visually and/or haptically-perceptible markings.

The outer circumferential surface is preferably a surface that extends along the circumference around the screw axis of the respective connecting part. It can consist of several partial surfaces, for example in the case of a hexagon similar to a nut, or can also have only one uniform surface, for example in the case of a cylindrical embodiment of the outer circumferential surface.

It is preferably provided that at least one seal is arranged in or on at least one connecting part in the receptacle. The seal does not necessarily have to be closed from all free sides by the connecting part or connecting parts. It is also possible that a part of the seal remains free to the outside. However, it is preferably provided that the seal is protected by the connecting parts and/or is enclosed on the outside when the at least two connecting parts are screwed together.

According to the invention, a sealing kit comprising at least one connecting element according to the invention and at least two different seals can also be provided. This allows the user to select the correct seal depending on the application or conditions and use it with the connecting element.

It is particularly advantageous if the receptacle for the seal is arranged in such a way that the contact pressure of the seal can be changed by the degree of screwing of at least two connecting parts, preferably at least partially continuously and/or in preferably at least three different values. This ensures that the contact pressure can be adjusted by the screw connection. This also applies if it is provided during further screwing that the contact pressure of the seal between the connecting parts is increased by the screwing.

It may preferably be provided that the first connecting part and the second connecting part can each have at least one wall between which the seal can be pressed together. The walls are preferably at an angle, particularly preferably normal in relation to the screw axes.

Furthermore, it is advantageous if at least the first scale and/or the second scale extends along an outer circumferential surface of the respective connecting part. The expression extending means that the respective scale is arranged in the circumferential direction in relation to the screw axis. The same applies if it is provided that at least the first scale and/or the second scale extends along an outer circumferential surface of the respective connecting part.

In order to enable better readability, it may be provided that the first scale and the second scale are arranged on outer circumferential surfaces of the respective connecting part, which are arranged next to each other in the screwed state. This makes it easy to determine the position of a reference marking in relation to the measurement markings of the first scale. The expression adjacent means that the scales are in close proximity to each other and that they extend along essentially parallel directions so that their relative position to each other can be determined. The same applies if it is provided that the first scale and the second scale are arranged on the outer circumferential surfaces of the respective connecting part in such a way that they are arranged next to each other when screwed together.

As a rule, during the detection of the position of a reference marking in relation to the measurement markings of the first scale, one or two measurement markings are determined that are at the same height along the circumferences or between which the reference marking lies.

It is preferably provided that at least the first scale and/or the second scale extends along an outer circumference of the respective connecting element by at least a quarter, preferably at least half and particularly preferably at least three quarters of the outer circumference. This ensures that a good determination of the relative position of a reference marking in relation to measurement markings can be achieved even with seals of particularly different shapes or materials. The same applies if it is provided that at least the first scale and/or the second scale extends along an outer circumference of the respective connecting element by at least a quarter, preferably at least half and particularly preferably at least three quarters of the outer circumference. It may be advantageous if at least one scale, preferably at least a first and/or at least a second scale, is segmented. The expression segmented means that the segmented scale is interrupted at at least one point along the outer circumference. Alternatively or additionally, more than one first scale and/or more than one second scale can also be provided on the respective connecting part.

Easier reading can be achieved if it is provided that the measurement markings differ at least partially from one another, preferably by shape, length and/or at least one symbol such as a font or number. This speeds up the adjustment. It also facilitates the exact recording of the relative position. This is because, as explained above, the properties or shape of the seal can change. Recording the relative positions at a certain point in time, such as the first assembly, can be helpful in determining the condition of the seal and predicting the expected further service life. For example, the measurement and/or reference markings may comprise several consecutive numbers, with or without measurement and/or reference markings in between, similar to a tape measure. It is particularly advantageous if the reference markings are at least partially provided with symbols such as letters, numbers or lettering. This enables easy reference to a specific embodiment or a specific material of seals.

It is preferably provided that at least the first scale is non-rotatable about the screw axis of the first connection part relative to the thread of the first connection part and/or a main body of the first connection part, at least in the screwed state with the second connection part. This prevents unintentional rotation of the scale relative to the main body during adjustment of the pressurization of the seal. The main body preferably comprises the thread. The same also applies if it is provided that at least the first scale is arranged non-rotatably about the screw axis of the first connection part relative to the thread of the first connection part and/or a main body of the first connection part, at least in the screwed state with the second connection part. Similarly, this also applies if it is provided that at least the second scale is arranged non-rotatably about the screw axis of the second connecting part with respect to the thread of the second connecting part and/or a main body of the second connecting part, at least in the screwed state with the first connecting part, and/or if it is provided that at least the second scale is arranged non-rotatably about the screw axis of the second connecting part with respect to the thread of the second connecting part and/or a main body of the second connecting part, at least in the screwed state with the first connecting part.

The connecting element can be designed as a stuffing box or comprise one.

It may also be provided that at least the first scale is non-rotatable about the screw axis of the first connecting part or second connecting part relative to a main body of the first connecting part and/or the second scale is non-rotatable relative to a main body of the second connecting part. For example, such an embodiment can be useful if the connecting element is designed as a stuffing box.

It is particularly advantageous if the second scale has at least one start reference marking and at least one end reference marking, wherein the distance between the start reference marking and the end reference marking along the second scale is designed as a function of the material and/or shape of at least one seal. This enables the user to immediately recognize what further twisting of the connecting parts is necessary to bring a particular seal into a tight position. This applies even if it is provided that the distance of the first reference marking and at least one other reference marking along the second scale is selected as a function of the material and/or the shape of the seal.

It may additionally or instead be provided that the second scale has at least one start reference marking and at least one end reference marking, wherein the distance between the start reference marking and the end reference marking along the second scale is or will be selected or set up as a function of other parameters. For example, the thread pitch can be included.

In this sense, it is particularly advantageous if the second scale has at least one start reference marking and at least two end reference markings, wherein the distance between a start reference marking and at least two end reference markings along the second scale is designed as a function of the material and/or shape of at least two different seals. In this way, a large number of different seal types or materials can be covered with just a few reference markings. This also applies if it is provided that the distance between the first reference marking and at least two other reference markings along the second scale is selected as a function of the material and/or shape of at least two different seals.

It may be provided that the seal is arranged in a groove of the receptacle in the screwed state and preferably that the groove has at least one venting area. This venting area can be designed to remove air in the groove and/or comprise at least one ventilation channel.

The venting area is preferably not completely covered by the seal. The expression covering means that at least part of the venting area is free of the seal, preferably at least during the insertion of the seal. It may be provided that the venting area is designed in such a way that it is completely covered by the seal in at least one screwed state. This can be the case, for example, if the seal is compressed in this screwed state and is thereby pressed into the venting area or onto the venting area. However, this is not detrimental to the effect of the venting area, as the air can escape until the seal has been fully inserted into the groove and compression begins.

The thickness of the groove and the thickness of the seal are preferably matched to each other. In this sense, the seal and the groove can be designed in such a way that the seal essentially fills the groove completely in the radial direction.

The venting area is preferably flow-connected to a rear side of the groove. This allows air to be guided from the inside of the groove to the outside when the seal is inserted into the groove. It may be provided that the venting area is flow-connected to an end face of the groove. It may also be provided that the venting area comprises a radial recess or nose of the groove. This can be arranged radially inwards and/or radially outwards.

Recess means that the groove has a wider cross-section in the area of the recess. If the seal is inserted into the groove, an air area remains in the recess and the air behind the seal can escape via this recess.

Nose means that the groove in the area of the nose has a smaller cross-section in the area of the nose. If the groove is inserted, it is pressed in locally by the nose, creating flow channels on the sides of the nose through which the air can escape behind the seal.

The groove is arranged in the first connecting part or in the second connecting part. It is also possible for both connecting parts to each have a groove.

The invention also relates to a marking kit comprising at least two marking strips, wherein the marking strips each have on at least a first side connecting means for attaching the marking strips to two different connecting parts of a connecting element for hoses, pipes or other fluid transport devices, wherein a first marking strip has on at least a second side at least one first scale with a plurality of measurement markings and wherein a second marking strip has on at least a second side at least a second scale with at least two reference markings.

Using a marking kit of this type, marking strips can be easily applied to existing connecting elements and thus the invention can also be used with connecting elements that have already been manufactured or even installed.

It may be provided that the marking kit has at least one, preferably a plurality of connecting elements for hoses, pipes or other fluid transport devices, each with at least two connecting parts, wherein the connecting parts can be screwed together around screw axes of the connecting parts, wherein at least one connecting part has at least one receptacle for a seal for sealing the connection between at least two of the connecting parts. This allows the user to attach the appropriate marking strips to the appropriate connecting elements as required.

At least one connecting device can, for example, have a connecting surface for connection to a connecting part. Adhesive can be arranged on this, for example.

It is preferably provided that the connecting device of at least one marking strip comprises an adhesive and that preferably at least one marking strip is designed as a sticker.

Preferably, the first side and the second side are opposite each other.

In the following, the invention is explained with reference to a non-limiting embodiment in the figures, wherein:

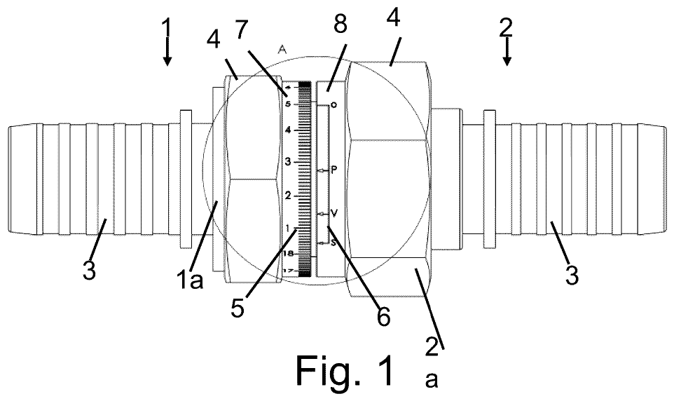

FIG. 1 shows a side view of a first embodiment of a connecting element according to the invention;

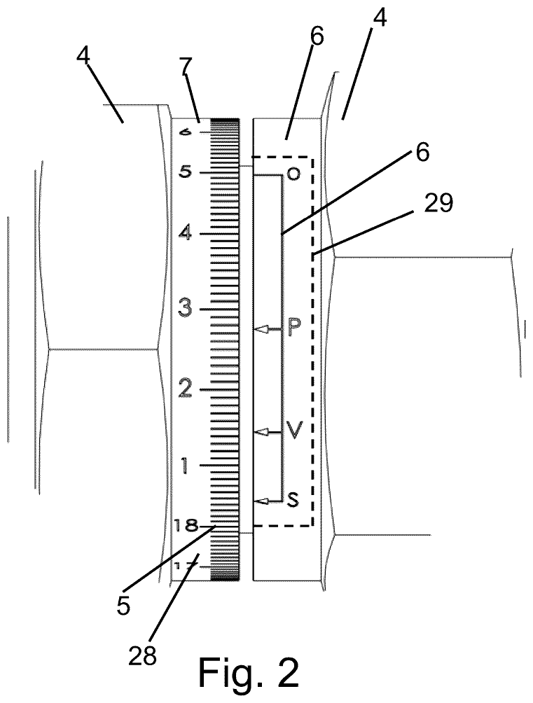

FIG. 2 shows a detail from FIG. 1;

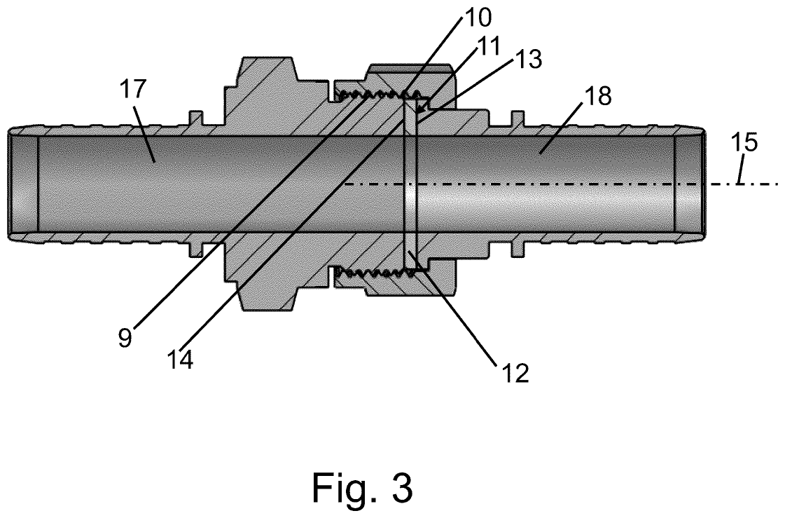

FIG. 3 shows a longitudinal section through the first embodiment;

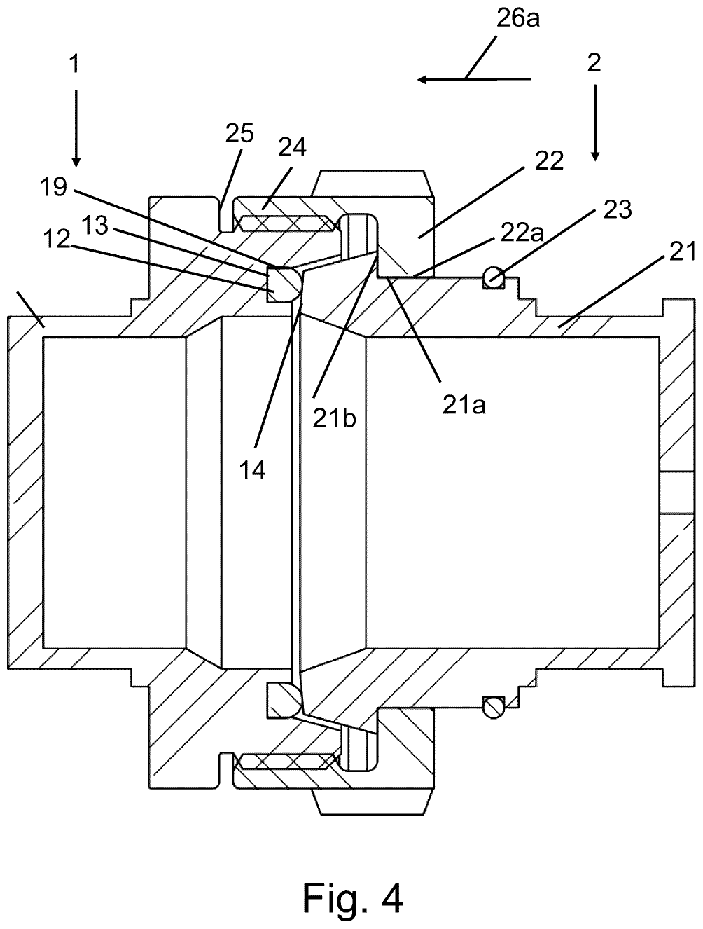

FIG. 4 shows a longitudinal section through a second embodiment according to the invention;

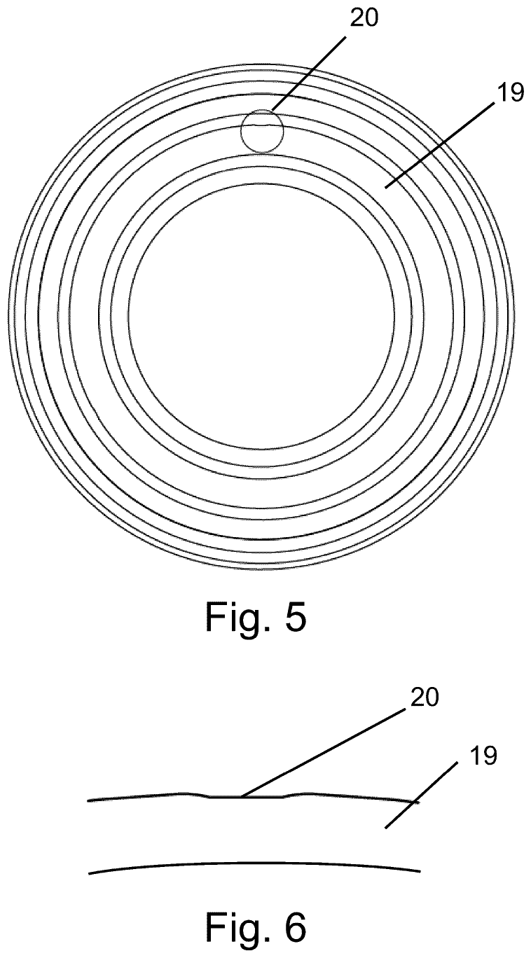

FIG. 5 shows a frontal view of the second connecting part of the second embodiment;

FIG. 6 shows an enlarged section from FIG. 5;

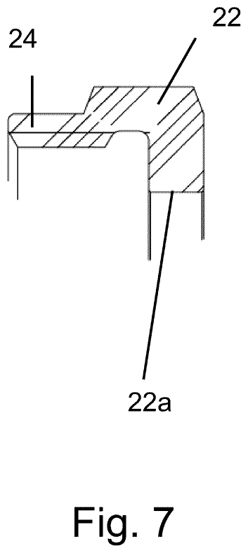

FIG. 7 shows part of the screw part enlarged;

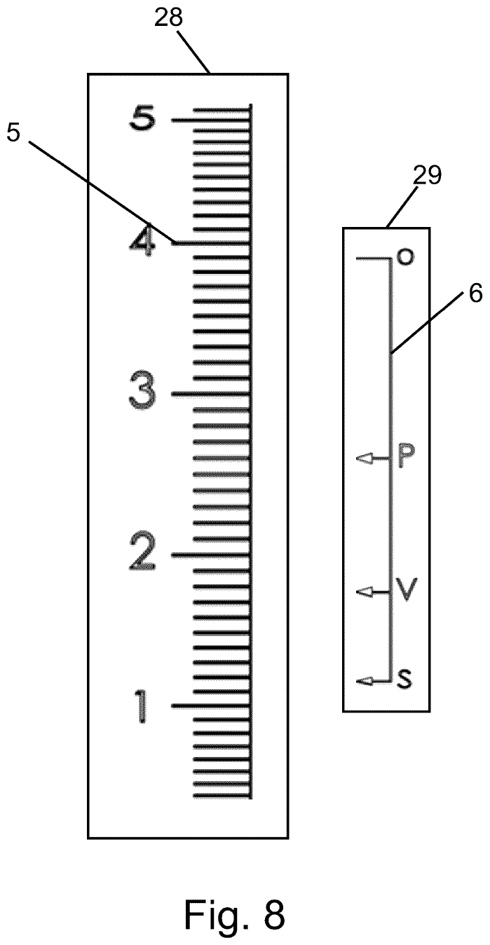

FIG. 8 shows a top view of a marking kit in a first embodiment according to the invention.

The first embodiment of the invention of a connecting element shown in FIGS. 1-3 has two connecting parts 1, 2, which are shown in FIG. 1 screwed into one another. They each have a main body 1a, 2a, wherein in this embodiment the first connecting part 1 is made in one piece. The second connecting part 2 is made in two pieces.

Both connecting parts 1, 2 each have a connecting region 3 at their end facing away from each other when screwed together, which is designed for connection to a hose, pipe or other fluid transport device. For this purpose, the connecting regions 3 preferably have ribs as shown to improve retention.

FIG. 3 shows that each connecting part 1, 2 has a channel 17, 18, which are flow-connected in the screwed position shown. This establishes the flow connection between the hoses, pipes or other fluid transport devices arranged on the connecting regions 3.

The main body 2a of the second connecting part 2 is not integrally connected to the connecting region 3 of the second connecting part 2. It is plugged into this and can be rotated in relation to the connecting region 3.

Furthermore, the connecting parts 1, 2 each have a gripping section 4. These can be used to connect them with standard wrenches or other suitable tools and thus adjust a mutual screwing of the connecting parts 1, 2. This gripping section 4 can, for example, comprise an edge ring and/or a slotted nut.

A first or second scale 5, 6 is arranged on at least one connecting part 1, 2 at the facing ends of the outer shells of the connecting parts 1, 2. This was achieved by using a marking kit according to the invention with two marking strips 28, 29 designed as stickers and a first marking strip 28 having the first scale 5 was stuck onto the first connecting part 1 and a second marking strip 29 having the second scale 6 was stuck onto the second connecting part 1. The second sides of the respective marking strips 28, 29 face away from the respective connecting part.

In the embodiment shown, a first scale 5 is arranged on the first connecting part 1 and a second scale 6 is arranged on the main body 3 of the second connecting part 2.

The outer shells have outer circumferential surfaces 7, 8 at the facing ends, which are essentially shaped as cylindrical shell surfaces. This allows the scales 5, 6 to be read easily and ensures that the scales 5, 6 are always opposite each other during screwing.

The first scale 5 has a plurality of measurement markings with over 180 measurement markings. Each measurement marking has one line, with every tenth line being extended and additionally provided with an ascending number. This makes it easier to read.

The second scale 6 has a total of 4 reference markings, but there can also be fewer. The first reference marking is a start reference marking marked with a zero and includes a dash. The other reference markings each have an arrow and are also marked with a letter. In this embodiment, these are “P”, “V” and “S”, but there may also be different lettering. They have different distances to the start reference marking along the outer circumferential surface 8 and are different end reference markings.

The sectional view in FIG. 3 shows that a first thread 9 of the main body 1a of the first connecting part 1 and a second thread 10 of the main body 2a of the second connecting part 2 are provided, which correspond to each other. In the figures, the threads 9, 10 are shown screwed together. The second connecting part 2 has a receptacle 11 without a groove, in which a seal 12 in the form of a sealing ring is inserted. The receptacle 11 is arranged on the connecting region 3. The receptacle 11 has a contact wall 13, which is at an angle, in this embodiment normal to the screw axis 15 of the second connecting part 2.

The first connecting part 1 has a pressing wall 14, which can press the seal 12 against the abutment wall 13 and thus achieve a seal between the first and second connecting parts 1, 2.

In FIG. 1 and FIG. 2, the connecting parts 1, 2 are shown in a first screw position in which the connecting parts 1, 2 are screwed into each other to such an extent that the press wall 14 rests against the seal 12 and this in turn rests against the contact wall 13, whereby further screwing is slowed down by the seal 12. As can be seen in FIGS. 1 and 2, the start reference marking is approximately at the height of the measurement marking “5”. The user can recognize by the increased resistance that he has reached the first screwing position and can read off this correspondence. Depending on the design and material of the seal 12, he then screws the connecting parts 1, 2 further into each other until the respective end reference marking is at the same height as the first scale 5, i.e. at the height of “5”. “P” stands for a PTFE (polytetrafluoroethylene) seal 12, “E” for one made of EPDM (ethylene propylene diene rubber), “S” for one made of silicone and “V” for one made of fluoroelastomers (“Viton®”). The respective end reference marking is used depending on the material of the seal 12 used.

FIGS. 4-6 show a second embodiment which, like the first embodiment, has a first and second scale according to the invention on the outside (not visible in the figures).

FIG. 4 shows that one connecting part, in this case the second connecting part 2, has an insert part 21 and a screw part 22, wherein the thread 10 and the second scale are arranged on the screw part 22. The connecting region 3 is connected to the insert part 21 in a non-rotatable manner and the screw part 22 is connected to the main body 2a in a non-rotatable manner. In an alternative embodiment, it may be provided that only one of these connections is non-rotatable.

The press wall 14 is arranged on the insert 21.

The screw part 22 has an inner circumferential wall 22a, the inner diameter of which corresponds to the outer diameter of a circumferential wall 21a of the insert part 21. The screw part 22 is thus guided in an axial direction along the insert part 21. Part of the screw part 22 is shown alone in FIG. 7.

Along this guide, the movement of the screw part 22 in the direction of the screw connection is positively limited by a shoulder 21b. This enables the insert part 21 to be pressed against the first connecting part 1 in the screwed state, as shown in FIG. 5.

Along this guide, the movement of the screw part 22 against the direction 26a of the screw connection is positively limited by a shoulder. This shoulder is represented by a ring 23 inserted into a groove of the insert part 21.

When the screw part 22 moves away from the screw connection in the unscrewed state against the direction 26a until it rests against the ring 23, it is arranged in a first end position. In this first end position, the screw part 22 projects axially beyond the insert part 21 on the side of the screw connection. It therefore also protrudes beyond the press wall 14 and thus protects it from damage while the connecting parts 1, 2 are not screwed together. The screw part 22 projects radially beyond the insert part 21 outside the insert part 21.

The first connecting part 1 has a receptacle with a radial groove 19 in which the seal 12 is inserted. The seal 12 completely fills the groove 19 in the radial direction. The groove base has the contact wall 13, on which the seal 12 is supported.

In the screwed state shown in FIG. 4, a screw section 24, which is designed as a screw sleeve, is spaced in the axial direction from the other connecting part, in this case the first connecting part 1. A shoulder 25 of the first connecting part 1 is arranged at a distance. This prevents the screw connection from being inhibited.

FIG. 5 shows a front view of the second connecting part 2 without the union nut. It can be seen that the groove 19 is essentially ring-shaped, into which the ring-shaped seal 12 can be inserted. At three points, the groove 19 has venting areas 20 on the radially outer side. The surroundings of a venting area 20 are shown enlarged in FIG. 6. These venting areas 20 are designed as noses that extend from the groove base, which is represented by a contact surface in the form of the contact wall 14, to the end face of the groove 19. The seal is pressed together locally by the nose, whereby venting channels are formed on both sides of each nose. If the seal 12 is pushed into the groove 19, it essentially fills the groove completely in the radial direction (visible in FIG. 4), except for the venting channels of the venting areas 20. The venting areas 20 thus form flow channels between the area of the groove 19 near the groove base (formed by the abutment wall 13) and the end face of the groove 19. This allows the air between the groove base and the seal 12 to escape via the venting areas 20.

FIG. 8 shows an embodiment of a marking kit according to the invention with two marking strips 28, 29, which are separate or separable from one another. The marking strips 28, 29 are shown in such a way that a second side is visible in each case, on which a first scale 5 is visible on a first marking strip 28 and a second scale 6 is visible on a second marking strip 29. The first sides of the marking strips 28, 29, which lie behind the second sides and are therefore not visible in the figure, are also provided with adhesive as a connecting device. This allows the marking strips 28, 29 to be glued to connecting parts.

1. A connecting element for hoses, pipes or other fluid transport devices, comprising:
at least two connecting parts, wherein the connecting parts can be screwed together about screw axes of the connecting parts, wherein at least one connecting part has at least one receptacle for a seal for sealing the connection between at least two of the connecting parts, wherein a first connecting part has at least one first scale with a plurality of measurement markings and a second connecting part has at least one second scale with at least two reference markings, and wherein the first scale and the second scale are opposite one another in the screwed state and can be rotated relative to one another by turning the screw connection.

2. The connecting element according to claim 1, wherein characterized in that the first scale and the second scale are arranged on outer circumferential surfaces of the respective connecting part, which are arranged next to each other in the screwed state.

3. The connecting element according to claim 1, wherein at least the first scale or the second scale extends along an outer circumference of the respective connecting element by at least a quarter of the outer circumference.

4. The connecting element according to claim 1, wherein the second scale has at least one start reference marking and at least one end reference marking, wherein the distance between start reference marking and end reference marking along the second scale is designed as a function of the material or shape of at least one seal.

5. The connecting element according to claim 1, wherein the second scale has at least one start reference marking and at least two end reference markings, wherein the distance between a start reference marking and at least two end reference markings along the second scale are designed as a function of the material or shape of at least two different seals.

6. The connecting element according to claim 1, wherein the seal is arranged in a groove of the receptacle in the screwed state and wherein the groove has at least one venting area.

7. The connecting element according to claim 1, wherein the first connecting part or the second connecting part has a main body and a screw part which can be rotated relative to the main body, wherein the screw part has at least one thread for screwing to the other connecting part.

8. The connecting element according to claim 7, wherein a relative, axial movement of the screw part with respect to the insert part against the direction of the screw connection is limited up to a first end position, and wherein the screw part projects beyond the insert part in the end position in the axial direction and on the side of the screw connection.

9. The connecting element according to claim 7, wherein the screw part is guided in the axial direction along the insert part via a form-fitting guide.

10. The connecting element according to claim 1, wherein a threaded section of the connecting element, which has an internal thread, is spaced apart from the other connecting part in the axial direction in the screwed state.

11. A sealing kit comprising at least one connecting element according to claim 1, wherein the sealing kit comprises at least two seals of different material or structure.

12. A method for connecting hoses, pipes or other fluid transport devices by means of a connecting element having at least two connecting parts, wherein the connecting parts are each flow-connected to at least one hose, pipe or other fluid transport device, wherein at least one seal is arranged in or on at least one receptacle of at least one connecting part and the connecting parts are screwed into one another, wherein:
a. at least one first connecting part and at least one second connecting part are screwed into one another into a first screw position until at least one connecting part rests against a seal of at least one other connecting part,
b. the position of at least a first reference marking of at least a second scale, which is arranged on a second connecting part, is recognized in relation to a plurality of measurement markings of at least a first scale, which is arranged on a first connecting part, in the first screwing position, and;
c. the connecting parts are then further screwed together until at least one other reference marking of the second scale assumes at least substantially the same position in relation to the first scale as the first reference marking during the first screw position.

13. The method according to claim 12, wherein the distance of the first reference marking and at least one other reference marking along the second scale is selected as a function of the material or the shape of the seal.

14. The method according to claim 12, wherein the first scale and the second scale are arranged on outer circumferential surfaces of the respective connecting part in such a way that they are arranged next to each other in the screwed state.

15. A marking kit comprising at least two marking strips, wherein the marking strips each have on at least a first side connecting means for attaching the marking strips to two different connecting parts of a connecting element for hoses, pipes or other fluid transport devices, wherein a first marking strip has on at least one second side at least one first scale with a plurality of measurement markings and wherein a second marking strip has on at least one second side at least one second scale with at least two reference markings.
